(19) United States
(12) Patent Application Publication
(10) Pub. No.: US 2020/0217623 A1
(43) Pub. Date: Jul. 9, 2020

(54) PROCESS FOR OBTAINING ANTI-TRAUMA LAYER TO BE APPLIED IN IMPACT ATTENUATION AND ENERGY DISPERSION SYSTEM

(71) Applicant: COPLATEX INDÚSTRIA E COMÉRCIO DE TECIDOS LTDA, SAO PAULO (BR)

(72) Inventors: CHRISTIAN CALLAS, SAO PAULO (BR); ÍTALO ATYLLA DA COSTA FARIAS, Sao Paulo (BR)

(21) Appl. No.: 16/655,323

(22) Filed: Oct. 17, 2019

(30) Foreign Application Priority Data
Jan. 7, 2019 (BR) 102019000276-0

(51) Int. Cl. F41H 5/04; B32B 5/02; B32B 5/26

(52) U.S. Cl. CPC F41H 5/0485; B32B 2571/02; B32B 5/26; B32B 5/02

(57) ABSTRACT

For joining, in a single loom stage, at least two fabric sheets (2) and (3) by interweaving their faces by fibers concurrent to the fabrics plane (4), forming anti-trauma ballistic layer (1). The separation between the fabric sheets (2) and (3) occurs according to the length of concurrent fibers (4), determining the thickness desired for the anti-trauma ballistic layer (1), in accordance with the type of protection in which it will be applied. Upon the impact of the projectile, the impact shock wave energy is dispersed along the length of concurrent fibers (4) between fabric sheets (2) and (3), and these same fibers (4), by their compression, absorb the energy, shock wave expansion and the elongation of the fabric sheets (2) and (3). Due to that effect, there is lower deformation of the bullet-proof vest, for example, preventing the traumatic shock and controlling the trauma caused by the impact and registered by the BFS deformation (BackfaceSignature).

The present descriptive report refers to a process to obtaining an anti-trauma ballistic layer, developed to reduce significantly the depth of trauma (BFS—BackfaceSignature) on the user (police officers, security agents, etc.), under ballistic impact, thus enabling dissipation of the projectile energy. The anti-trauma layer controls the energy absorption by its constructive form, which uses the “spring arrangement” concept, and is comprised by two fabric/composite sheets (resistant to pulling and with variable thickness), warped and joined each other by single yarns concurrent to the fabrics plane, by weaving process (also varying the thickness, and especially the length), and forming a ballistic layer, which when inserted in an assembly with the ballistic blanket of a bullet-proof vest, or in the lining of vehicle armoring, reduces the deformation energy on the counter-support (supporting material) up to 50%. When combined with other conventional armoring means that form the ballistic blanket, this anti-trauma ballistic layer also prevents rip of the layers with greater longitudinal stretching, complementing the proposed protection.

### BACKGROUND OF THE INVENTION

As generally known, the major technical standards applied to the classification and validation of ballistic composites (e.g. NIJ STD 0101.04 and NIJ STD 0101.06) establish limits for the deformation (acceleration) caused by projectile impacts, and these limits were standardized by using a standard supporting material where the ballistic composite is supported during the ballistic test. BFS (BackfaceSignature) is the deformation over the testimony mass (supporting material) after the ballistic impact. To control this deformation, we currently use materials with specific properties for energy dispersion or yield strength (elongation), in addition to materials/composites, such as nonwoven Needle Felt (composite of discontinuous fibers with random orientation), which acts as an excellent impact energy dispersion agent, as the random fibers carry the impact energy in all the directions. Therefore, the greater is the number of directions, the better will be the energy dispersion, always considering continuous fibers, as the discontinuous ones do not transfer energy for long runs.

In addition to the construction of woven and non-woven fabrics and composites as a BFS control form, it shall be also considered the tensile strength of yarns and their elongation. High-toughness fibers usually have low elongation, while fibers with lower toughness, such as PES (Polyester) and PA (Polyamide “Nylon”) have higher elongation. As anti-trauma materials, the optimal condition is to combine tensile strength and elongation.

Another key factor related to impact energy absorption is the transfer speed of this energy. For this concept, we may assume, as a test, several fabric sheets supported on a rigid surface, being impacted by a projectile, and under this condition, the layers that cannot be deformed by direct action of the rigid counter-support are not sheared more quickly, and the armoring will be transfixed. In a similar way, if the counter-support is too soft, the fabric layers do not ‘sink’ in the supporting mass, opening the fabrics by the drag effect, and the projectile will perforate again. As shown in FIG. 1 (inserted for example purposes for the patent application to be described later), this effect occurs upon the impact, when the shock energy caused by the projectile was abruptly transferred to the fabric between the impact point and the counter-support base. Thus, we understand that the ration between the ballistic layers and the counter-support (supporting material) is very important, as the damages to the layers in contact with the counter-support occur in function of the elongation vs. rip tension ratio, and obviously, by the energy transferred in the impact point. High-toughness fibers usually have low elongation, while fibers with lower toughness, such as PES (Polyester) and PA (Polyamide Nylon) have greater elongation property. Thus, an optimal anti-trauma material shall associate tensile strength with good elongation properties.

When using a composite with anti-trauma material, such as Needle Felt, as shown in FIG. 2 (inserted for example purposes for the patent application to be described later), the means for dispersion of the energy transferred between fibers and counter-support, which attenuate the shock wave on the supporting material, are usually made of aerated materials, foams and felts. The dispersion depends on the strength to rip of these materials used, as they are compressed in their thickness and pulled along their extension upon impact. Anyway, the composites require several layers of protective fabrics for the anti-ballistic effect and control of the trauma caused by the projectile impact. Many times, even that no perforation occurs, the impact is so strong that eventually causes bruises, and in more severe cases, affecting internal organs resulting in hemorrhage, and consequently may cause death of the user of a bullet-proof vest.

As shown in the Brazilian document PI 9903448-4, the armoring is composed by a top fabric (4) followed by anti-ballistic blanket (3), and more internally, an assembly of anti-trauma plate (6) comprised by superposition of sheets (6a) made of synthetic fibers, with varied thicknesses, seamed between two fabric layers (6b). This arrangement is shown for example purpose, as FIG. 3 of the application to be described later.

Thus, armoring in vests shall necessarily have, in the layer closest to the user's body (counter-support), an anti-trauma layer, currently used to dissipate the projectile shock energy.

### DESCRIPTION OF THE INVENTION

To solve these problems, we developed the anti-trauma ballistic layer in question, which is the reason for this patent application, that is, a layer made by weaving, where fabric/composite sheets, with high strength against rip and elongation, are woven interleaved each other by fibers concurrent to the fabrics planes. These fibers vary the fabric thickness and the interweaving concurrent to the fabrics plane provides remarkable strength to the fabric or composite sheets, forming the anti-trauma ballistic layer in question, to be used, for example, in blankets for ballistic vests or armoring of vehicles. Another benefit achieved with this “spring arrangement, is the light weight of this anti-trauma ballistic layer, in addition to the fact that it does not absorb water and provides high resistance to abrasion, which are problems found in the technologies available in the market, thus providing greater comfort to the user of a bullet-proof vest, for example.

As possible combinations, this anti-trauma ballistic layer can be used in several units joined each other in the ballistic blanket, associated to conventional armoring means, or even combined with woven and/or nonwoven fabric separator.

With this superficial explanation, the anti-trauma ballistic layer is better understood by its specific characteristics, tensile strength and elongation properties, by the attached drawings.

### BRIEF DESCRIPTION OF THE DRAWINGS

FIG. 1—shows an effect of impact on the armoring without anti-trauma layer;

FIG. 2—shows the effect on armoring with conventional anti-trauma layer;

FIG. 3—shows the prior art Brazilian patent document PI 9903448-4;

FIG. 4—shows in perspective, and separately (for better understanding of the textile construction process), the warped fabric sheets that are woven and have their faces simultaneously interweaved by fibers concurrent to the fabrics plane, in single loom stage;

FIG. 5—shows, laterally, the warped fabric sheets joined each other by fibers concurrent to the fabrics plane, thus forming the anti-trauma layer;

FIG. 6—elevation view, according to the previous figure, showing the anti-trauma ballistic layer and the counter-support;

FIG. 7—perspective view according to the previous figure;

FIG. 8—perspective view of the anti-trauma ballistic layer after ballistic impact;

FIG. 9—side view showing, schematically, the anti-trauma ballistic layer after ballistic impact. In this condition, the concurrent fibers act as springs, in oscillating system, causing dispersion of the energy caused by the impact shock, indicated by the arrows;

FIG. 10—sequential view of possible combinations for the anti-trauma ballistic layer. Detail A shows two units mounted. Detail B shows one anti-trauma ballistic layer and a conventional armoring layer with interleaved woven and/or nonwoven fabric. Detail C shows two anti-trauma ballistic layers with one conventional armoring layer, with insertion of woven and/or nonwoven fabric separators between them. Such combinations can be bond to each other or not.

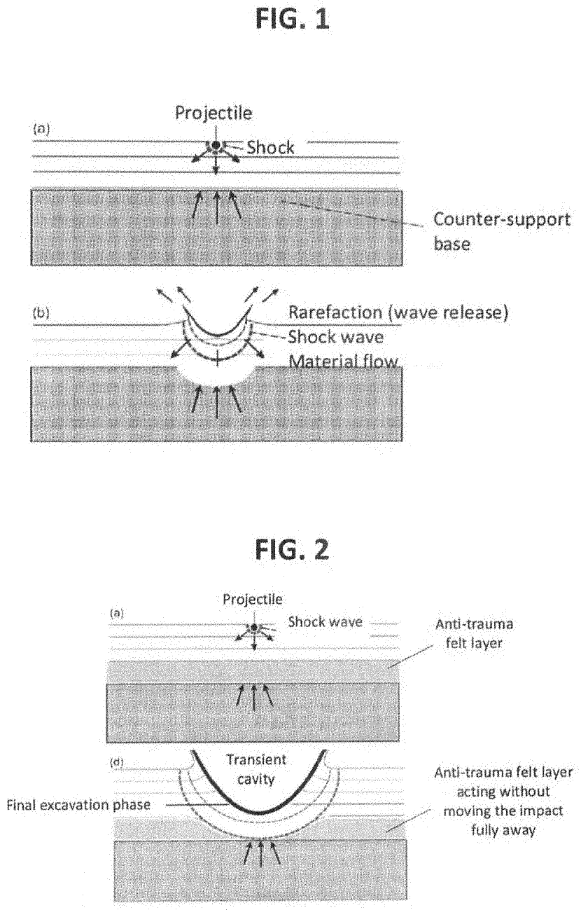

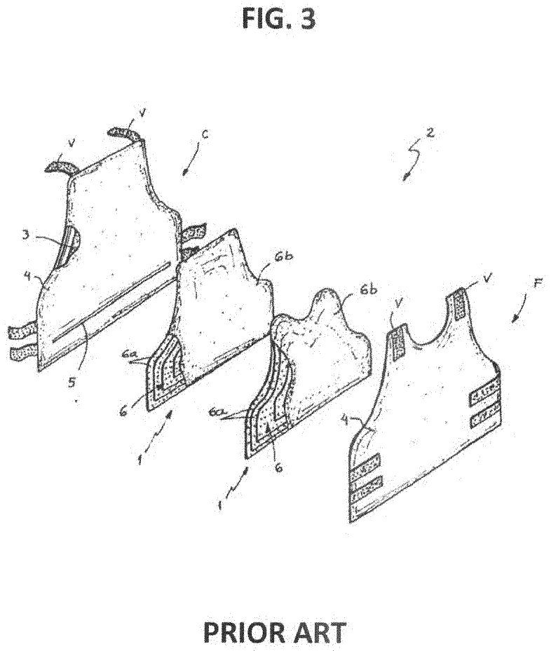

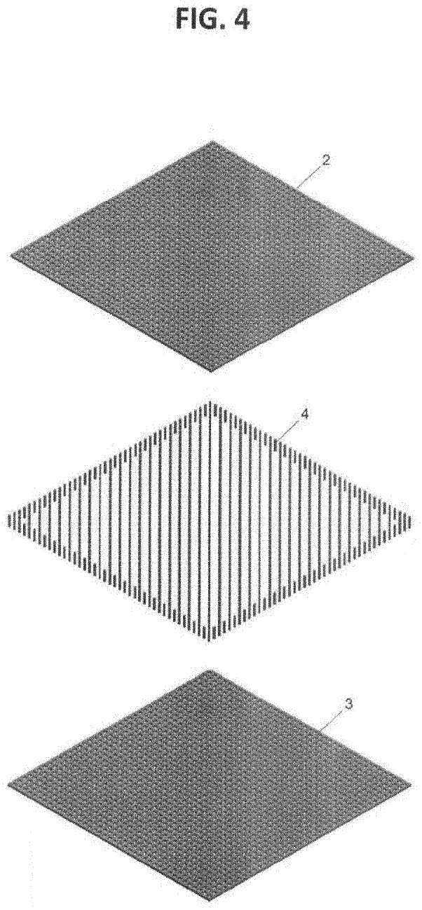

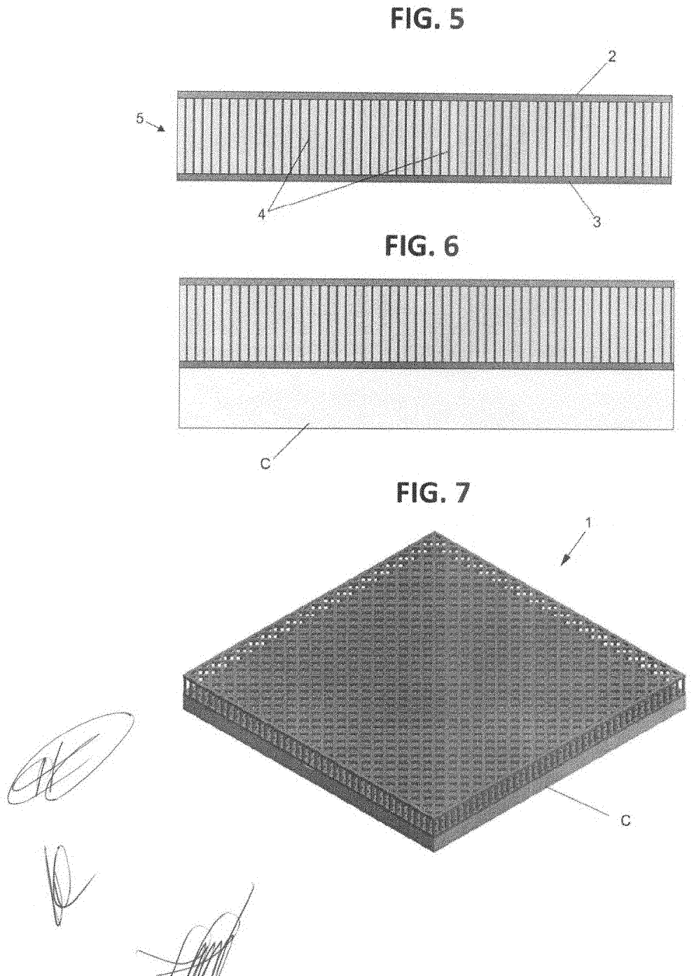

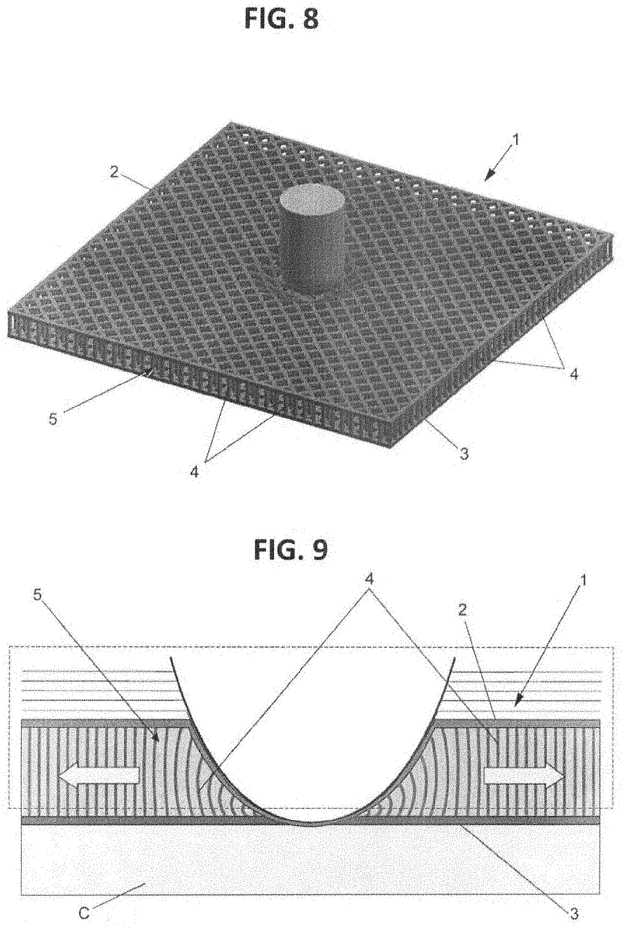

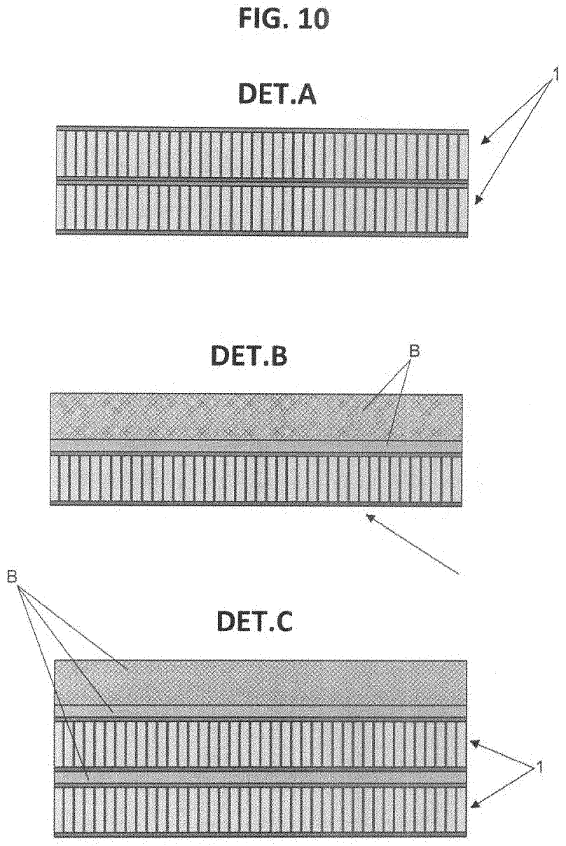

### DETAILED DESCRIPTION OF THE INVENTION

In compliance with the drawings above, the object of the present application for invention patent, is comprised by an anti-trauma ballistic layer (1) used as final layer, previously the counter-support (supporting material) (C), in an anti-ballistic blanket for vests, vehicular armoring and others (not shown). The layer (1) is composed by two fabric sheets (2) and (3), which are vertically joined by fibers concurrent to the fabrics plane (4). For the textile construction of this anti-trauma ballistic layer (1), a special loom is used, as the warp occurs in a single stage, in specific loom, working with needles weaving in cross angles, i.e. needles that work in the vertical and horizontal directions at the same time.

Thus, weaving of the fabric sheets (2) and (3) begins, by warping their faces while weaving perpendicularly the fibers concurrent to the fabrics plane (4) for interweaving and joining of the set. Therefore, the fibers concurrent to the fabrics plane (4) are interweaved concurrently, forming an intermediate filling (5) between the fabric sheets (2) and (3), finally achieving the single-piece anti-trauma layer (1).

The application of the anti-trauma layer (1) is made before the counter-support (supporting material) (C) after the anti-ballistic blanket of ballistic vests, and also in armoring linings of vehicles, and can be used in any situations that require efficient protection against impacts from projectiles and collisions. Thus, the fabric sheets (2) and (3) can present density variations by using yarns with varied thicknesses, as well as fiber concurrent to the fabrics plane (4), which may vary its yarns, providing better level of strength according to the application of this anti-trauma ballistic layer (1).

By using this anti-trauma layer (1) and its physical and constructive characteristics, we achieved up to 40% less trauma to the vest user, primarily due to the characteristics of the intermediate filling (5) formed by interweaving with fibers concurrent to the fabrics plane (4). These receive the shock, dispersing it along their length until reaching one of the fabric layers (2) or (3), reducing the rip of fabrics and deformation of the counter-support up to 40% less in relation to the conventional materials, in benchmarks with other technologies currently available.

Along the length of fibers concurrent to the fabrics plane (4), during the loom stage, the anti-trauma ballistic layer (1) obtained may eventually have its thickness more or less significant according to the need for its application. That is, once the fibers concurrent to the fabrics plane (4) are woven with longer length, there is greater separation between the fabric sheets (2) and (3), and the anti-trauma ballistic layer (1) acquires greater thickness. Once the fibers concurrent to the fabrics plane (4) are woven with smaller length, there is smaller separation between the fabric sheets (2) and (3), and the anti-trauma ballistic layer (1) acquires smaller thickness.

The anti-trauma layer (1) can be used associated with other conventional armoring means (B), with or without woven and/or nonwoven fabric separators, whether or not bond to each other.

1- Process for obtaining an anti-trauma layer, is constituted from an anti-trauma ballistic layer (1) produced in specific loom, having needles weaving in cross angles, in the vertical and horizontal directions at the same time, such layer (1) used as final layer, anti-trauma, previously the counter-support (supporting material) (C) in anti-ballistic blanket (M) for vests, vehicular armoring, and others, with one layer (1) composed by two or more fabric sheets (2) and (3) characterized by, during their production in the loom, in a single stage, having their faces warped simultaneously interweaved in a form concurrent to the fabrics plane by fibers (4), forming an intermediate concurrent filling (5) between these fabric sheets (2) and (3), and forming the anti-trauma layer (1).

2- Impact attenuation energy dispersion system characterized by the shock energy dispersion along the length of fibers concurrent to the plane of fabrics (4) between the anti-trauma fabric sheets (2) and (3), such fibers (4) concentrating energy along the intermediate filling (5) for controlled energy dispersion by fiber compression, shock wave expansion and elongation of fabric sheets (2) and (3).

3- Impact and attenuation energy dispersion system according to claim 2, characterized by the length of fibers being concurrent to the fabrics plane (4) for spacing between fabric sheets (2) and (3), determining the thickness desired for the anti-trauma ballistic layer (1).
